(19) United States
(12) Patent Application Publication
(10) Pub. No.: US 2007/0155948 A1
(43) Pub. Date: Jul. 5, 2007

(54) Multi-functional polyamic acids, and compositions and methods relating thereto

(76) Inventors: Tadashi Ishibashi, Toyoake Aichi (JP); Hirokazu Yokoyama, Handa Aichi (JP)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/322,822

(22) Filed: Dec. 30, 2005

(51) Int. Cl. C08G 69/08

(52) U.S. Cl. 528/310

(57) ABSTRACT

The present invention is directed to polyamic acids comprising a diamine represented by the following formula, 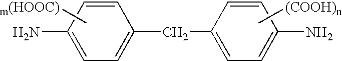 where m is an integer between and including any two of the following numbers 0, 1, 2, 3 and 4 and wherein n is an integer between and including any two of the following numbers 0, 1, 2, 3 and 4. The sum of m+n is equal to any integer between and including any two of the following numbers 1, 2, 3, 4, 5, 6, 7, 8.

### BACKGROUND INFORMATION

1. Field of the Disclosure

This invention relates to polyamic acids useful in the manufacture of flexible circuit boards. More specifically, the polyamic acids of the present invention can be imidized to form polyimide substrates with advantageous metal bonding properties.

2. Description of Related Art

The polyimide films of the present invention are broadly used with metal foils (like copper foil) to form a polyimide metal laminate. These laminates can be used to form a flexible printed circuit board. See generally, Japanese Laid Open Patent Publication 8-41227, Japanese Laid Open Patent Publication 6-336533, Japanese Laid Open Patent Publication 2003-27014 and Japanese Laid Open Patent Publication 8-157629A

Generally speaking, conventional films often require some degree of post-processing to improve surface topography for film adhesion. Oftentimes, silane-coupling agents are applied to the surface of a polyimide film to improve adhesion between the metal foil and polyimide substrate. However, coupling agents and surface treatments (such as plasma treatment) can be expensive, complicated, and prone to unwanted delamination.

### SUMMARY

The present invention is directed to polyamic acids comprising a diamine component and a dianhydride component. The diamine component comprises from 0.1 to 100 mole percent of a diamine represented by formula 1 below 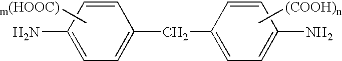
wherein m is an integer between and including any two of the following numbers 0, 1, 2, 3 and 4, wherein n is an integer between and including any two of the following numbers 0, 1, 2, 3 and 4, wherein the sum of m+n is equal to any integer between and including any two of the following numbers 1, 2, 3, 4, 5, 6, 7, 8, and wherein the dianhydride component is an aromatic tetracarboxylic dianhydride or chemical derivative thereof.

### DETAILED DESCRIPTION

In one embodiment of the present invention, a polyamic acid is formed from a diamine component, a dianhydride component and a suitable solvent. The diamine component comprises from between and including any two of the following numbers 0.1, 0.2, 0.5, 1.0, 2.0, 5.0, 10.0, 15.0, 20.0, 25.0, 30.0, 35.0, 40.0, 45.0, 50.0, 55.0, 60.0, 65.0, 70.0, 75.0, 80.0, 85.0, 90.0, 95.0 and 100 mole percent of a diamine represented by the following formula, 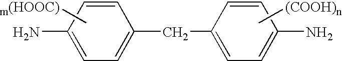
where m is an integer between and including any two of the following numbers 0, 1, 2, 3 and 4 and where n is an integer between and including any two of the following numbers 0, 1, 2, 3 and 4. The sum of m+n is equal to any integer between and including any two of the following numbers 1, 2, 3, 4, 5, 6, 7, 8. In one embodiment, the diamine is 3,3′-dicarboxy-4, 4′-diaminodiphenyl methane. In another embodiment, a useful range of the diamine shown above can be from 1, 2, 5, 10, 15 or 20 mole percent of the total diamine component. The dianhydride component can be an aromatic tetracarboxylic dianhydride or any chemical derivative thereof including, but not limited to acids, acid esters, acid halides and the like.

Suitable solvents useful in the practice of the present invention include any solvent capable of dissolving a polyamic acid. Some of these solvents include, but are not limited to, sulfoxide solvents (dimethyl sulfoxide, diethyl sulfoxide, etc.), formamide solvents (N,N-dimethylformamide, N,N-dimethylformamide, etc.), acetamide solvents (N,N-dimethylacetamide, N,N-dimethylacetamide, etc.), pyrrolidone solvents (N- methyl-2-pyrrolidone, N-vinyl-2-pyrrolidone, etc.), phenol solvents (phenol, o-, m- or p-cresol, xylenol, halogenated phenols, catechol, etc.), hexamethylphosphoramide and gamma-butyrolactone. It is desirable to use one of these solvents or mixtures thereof. It is also possible to use combinations of these solvents with aromatic hydrocarbons such as xylene and toluene, or ether containing solvents like diglyme, propylene glycol methyl ether, propylene glycol, methyl ether acetate, tetrahydrofuran, and the like.

In one embodiment of the present invention, the polyamic acid can comprise additional monomers that can react with the polyamic acid to form a copolyamic acid. Suitable diamine monomers can be represented by the following structures,

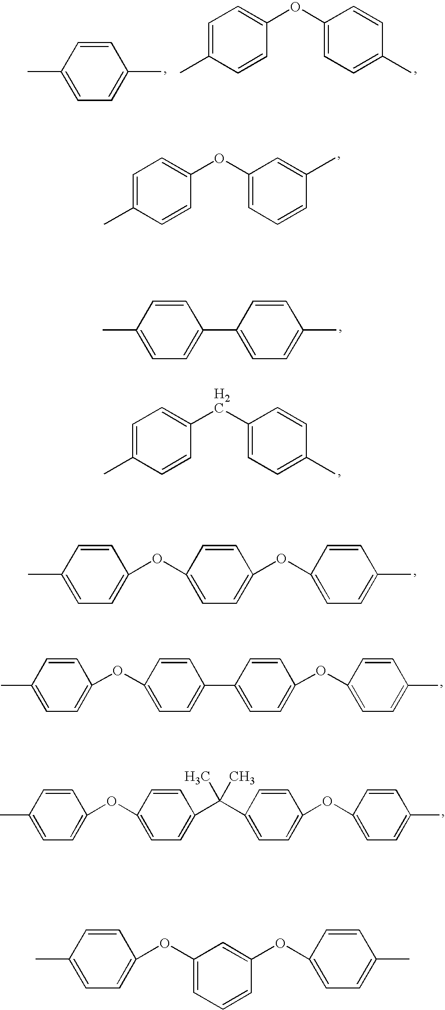

Suitable dianhydrides can include structures having the following formula,

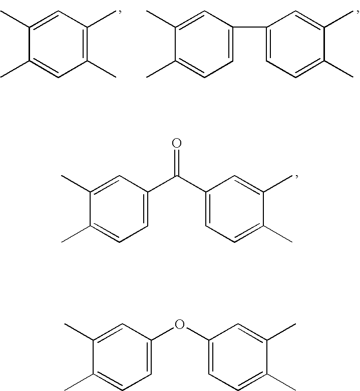

### Other Co-monomers

Additional co-monomers can optionally be used in synthesizing the preferred polyimide polymers of the present invention, provided that the additional co-monomers are less than 30, 25, 20, 15, 10, 5, 2, 1 or 0.5 mole percent of the final polyimide polymer. Any of the following are examples that may be used as an additional co-monomer for embodiments of the present invention:

1. 2,3,6,7-naphthalene tetracarboxylic dianhydride;

2. 1,2,5,6-naphthalene tetracarboxylic dianhydride;

3. benzidine;

4. substituted benzidine (e.g., 2,2′-bis(trifluoromethylbenzidine)

5. 2,3,3′,4′-biphenyl tetracarboxylic dianhydride;

6. 2,2′,3,3′-biphenyl tetracarboxylic dianhydride;

7. 3,3′,4,4′-benzophenone tetracarboxylic dianhydride;

8. 2,3,3′,4′-benzophenone tetracarboxylic dianhydride;

9. 2,2′,3,3′-benzophenone tetracarboxylic dianhydride;

10.2,2-bis(3,4-dicarboxyphenyl) propane dianhydride;

11. bis(3,4-dicarboxyphenyl) sulfone dianhydride;

12.1,1-bis(2,3-dicarboxyphenyl) ethane dianhydride;

13.1,1 -bis(3,4-dicarboxyphenyl) ethane dianhydride;

14. bis(2,3-dicarboxyphenyl) methane dianhydride;

15. bis(3,4-dicarboxyphenyl) methane dianhydride;

16. 4,4′-(hexafluoroisopropylidene) diphthalic anhydride

17. oxydiphthalic dianhydride;

18. bis(3,4-dicarboxyphenyl) sulfone dianhydride;

19. bis(3,4-dicarboxyphenyl) sulfoxide dianhydride;

20. thiodiphthalic dianhydride;

21. 2,2 bis-(4-aminophenyl) propane;

22. 4,4′-diamino diphenyl methane;

23. 4,4′-diamino diphenyl sulfide;

24. 3,3′-diamino diphenyl sulfone;

25. 4,4′-diamino diphenyl sulfone;

26. 4,4′-diamino diphenyl ether;

27. 1,5-diamino naphthalene;

28. 4,4′-diamino-diphenyl diethylsilane;

29. 4,4′-diamino diphenylsilane;

30. 4,4′-diamino diphenyl ethyl phosphine oxide;

31. 4,4′-diamino diphenyl N-methyl amine;

32. 4,4′-diamino diphenyl-N-phenyl amine;

33. 1,3-diaminobenzene;

34. 1,2-diaminobenzene;

35. 2,2-bis(4-aminophenyl) 1,1,1,3,3,3-hexafluoropropane;

36. 2,2-bis(3-aminophenyl) 1,1,1,3,3,3-hexafluoropropane;

37. and the like.

The polyimide film according to the present invention can be produced by combining the above monomers together with a solvent to form a polyamic acid (also called a polyamide) solution.

The dianhydride and diamine components are typically combined in a molar ratio of aromatic dianhydride component to aromatic diamine component of from 0.90 to 1.10. Molecular weight can be adjusted by adjusting the molar ratio of the dianhydride and diamine components.

The polyamic acid casting solution is derived from the polyamic acid solution. The polyamic acid casting solution preferably comprises the polyamic acid solution combined with conversion chemicals like: (i) one or more dehydrating agents, such as, aliphatic acid anhydrides (acetic anhydride, etc.) and aromatic acid anhydrides; and (ii) one or more catalysts, such as, aliphatic tertiary amines (triethylamine, etc.), aromatic tertiary amines (dimethylaniline, etc) and heterocyclic tertiary amines (pyridine, picoline, isoquinoilne, etc). The anhydride dehydrating material it is often used in a slight molar excess of the amount of amide acid groups in the copolyamic acid. The amount of acetic anhydride used is typically about 2.0-3.0 moles per equivalent of copolyamic acid. Generally, a comparable amount of tertiary amine catalyst is used. In one embodiment, the polyamic acid solution and/or the polyamic acid casting solution are dissolved in an organic solvent at a concentration from about 5, 10 or 12% to about 12, 15, 20, 25, 27, 30 or from about 40,45, 50, 55, 60, 65, 70, 75, 80, 85, or 90% by weight.

The solvated mixture (the polyamic acid casting solution) can then be cast or applied onto a support, such as an endless belt or rotating drum, to give a film. Next, the solvent containing-film can be converted into a self-supporting film by baking at an appropriate temperature (thermal curing) together with conversion chemical reactants (chemical curing). The film can then be separated from the support, oriented such as by tentering, with continued thermal and chemical curing to provide a polyimide film.

In one embodiment of the present invention a polyimide can be represented by the following formula, 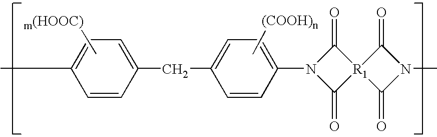
where m is an integer between and including any two of the following numbers 0, 1, 2, 3 and 4 and where n is an integer between and including any two of the following numbers 0, 1, 2, 3 and 4. Here, the sum of m+n is equal to any integer between and including any two of the following numbers 1, 2, 3, 4, 5, 6, 7, 8 and R₁, can be represented by any one, or combination, of the following structural units,

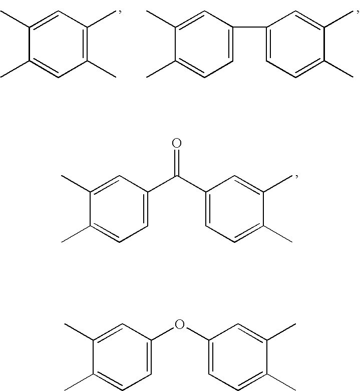

In one embodiment of the present invention, a tetracarboxylic acid is used to form a polyamic acid precursor material. The tetracarboxylic acid can be a pyromellitic acid, 3,3′,4,4′-biphenyltetracarboxylic acid, 2,2′,3,3′-biphenyltetracarboxylic acid, 3,3′,4,4′-benzophenonetetracarboxylic acid, 2,3,6,7-naphthalene dicarboxylic acid, 2,2-bis(3,4-dicarboxyphenyl) ether, and mixtures of these. To the tetracarboxylic acid is added a diamine comprising a moiety consisting of a carboxy-4,4′-diaminodiphenyl methane. These components are reacted to form a polyamic acid as precursor material.

Useful methods for producing polyimide film in accordance with the present invention can be found in US 5,166,308 which is hereby incorporate by reference into this specification for all teachings therein. Numerous variations are also possible, such as: (a) a method wherein the diamine components and dianhydride components are preliminarily mixed together and then the mixture is added in portions to a solvent while stirring, (b) a method wherein a solvent is added to a stirring mixture of diamine and dianhydride components (contrary to (a) above), (c) a method wherein diamines are exclusively dissolved in a solvent and then dianhydrides are added thereto at such a ratio as allowing to control the reaction rate, (d) a method wherein the dianhydride components are exclusively dissolved in a solvent and then amine components are added thereto at such a ratio to allow control of the reaction rate, (e) a method wherein the diamine components and the dianhydride components are separately dissolved in solvents and then these solutions are mixed in a reactor, (f) a method wherein the polyamic acid with excessive amine component and another polyamic acid with excessive dianhydride component are preliminarily formed and then reacted with each other in a reactor, particularly in such a way as to create a non-random or block copolymer, (g) a method wherein a specific portion of the amine components and the dianhydride components are first reacted and then the residual diamine components are reacted, or vice versa, (h) a method wherein the conversion chemicals are mixed with the polyamic acid to form a polyamic acid casting solution and then cast to form a gel film, (i) a method wherein the components are added in part or in whole in any order to either part or whole of the solvent, also where part or all of any component can be added as a solution in part or all of the solvent, (j) a method of first reacting one of the dianhydride components with one of the diamine components giving a first polyamic acid. Then reacting the other dianhydride component with the other amine component to give a second polyamic acid. Then combining the amic acids in any one of a number of ways prior to film formation.

The thickness of the polyimide film may be adjusted depending on the intended purpose of the film or final application specifications. It is generally preferred that the thickness of the film ranges from 2, 3, 5, 7, 8, 10, 12, 15, 20, or 25 microns to about 25, 30, 35, 40, 45, 50, 60, 80, 100, 125, 150, 175, 200, 300, 400 or 500 microns. Preferably, the thickness is from about 8 to about 125 microns.

Polyimide films according to the present invention can be used as a base film for a laminate for incorporation into a flexible printed circuit board (“FPC”). In one embodiment, a flexible printed circuit board (“FPC”) can be produced as follows:
1. applying an adhesive (onto the polyimide film of the present invention) and drying;
2. laminating a copper or other conductive foil;
3. hardening the adhesive; and
4. forming a circuit pattern (broadly speaking: application of a resist, photo-patterning and development of the resist, copper etching and removal of the resist).

Examples of adhesives useful in forming the adhesive layer include thermoplastic polyimide resins, epoxy resins, phenolic resins, melamine resins, acrylic resins, cyanate resins and combinations thereof. In one embodiment, the adhesive is a polyimide thermoplastic resin, optionally further comprising a thermosetting adhesive, such as, epoxy resin and/or phenolic resin. For adhesives having both thermoplastic and thermosetting components, the content of the thermosetting resin in the adhesive layer generally ranges from 5 to 400 parts by weight, preferably from 50 to 200 parts by weight, per 100 parts by weight of resin components other than the thermosetting resin.

Typically, adhesion strength of the above-described laminates can be improved by employing various techniques for elevating adhesion strength. In the practice of the present invention however, many of these techniques can be avoided, eliminating unwanted costs and unwanted processing steps. For example, prior to the step of applying the adhesive onto the polyimide film or laminating an adhesive sheet thereon, a polyimide film can be subjected to a pre-treatment step (heat treatment, corona treatment, plasma treatment under atmospheric pressure, plasma treatment under reduced pressure, treatment with coupling agents (like polyamic acids oligomers and silanes), sandblasting, alkali-treatment, acid-treatment, etc.). In addition to these methods another method is to improve the adhesion strength by adding to the polyamic acid various metal compounds as disclosed in U.S. Pat. No. 4,742,099. The present invention advances the art in that many (if not all) of these techniques can be avoided so that good bondability is maintained under thermal aging conditions.

### EXAMPLES

The advantages of the present invention are illustrated in the following examples. These examples are not intended to limit the scope of this invention.

### Example 1

1.91 grams of 3,3′-dicarboxy-4,4′-diaminodiphenyl methane diamine (6.7 mmol), 17.81 grams of 4,4′-diaminodiphenyl ether (88.9 mmol), and 149.6 grams of N,N′-dimethylacetamide were put into 300ml separable flask equipped with DC stirrer. The mixture was agitated at room temperature under a nitrogen atmosphere for one hour. Next, 20.24 grams (92.8 mmol) of pyromellitic dianhydride was added to the mixture. After one hour of agitation, 9.12 grams of 6.0 wt % pyromellitic dianhydride solution was added over 30 minutes. Agitation was continued for an additional 1 hour to obtain a polyamic acid solution.

Next, 100 grams of the polyamic acid solution was cast onto a polyester film. The uniform coating film was formed using spin coater.

The two films were heated at 100 degrees C. for 30 minutes. The polyamic acid film was self-supporting and was removed from the polyester film. The polyamic acid film was then heated at 200 degrees C. for 30 minutes, at 300 degrees C. for 30 minutes and at 400 degrees C. for 5 minutes to obtain a polyimide film. The polyimide was laminated to copper foil using an adhesive.

### Example 2

2.72 grams of 3,3′-dicarboxy-4,4′-diaminodiphenyl methane diamine (9.5 mmol), 17.14 grams of 4,4′-diaminodiphenyl ether (85.6 mmol), and 149.7 grams of N,N′-dimethylacetamide were put into 300ml separable flask equipped with DC stirrer. The mixture was agitated at room temperature under a nitrogen atmosphere for one hour. Next, 20.11 grams (92.2 mmol) of pyromellitic dianhydride was added to the mixture. After one hour of agitation, 9.62 grams of 6.0 wt % pyromellitic dianhydride solution was added over 30 minutes. Agitation was continued for an additional 1 hour to obtain a polyamic acid solution.

Next, 100 grams of the polyamic acid solution was cast onto a polyester film. The uniform coating film was formed using spin coater.

The two films were heated at 100 degrees C. for 30 minutes. The polyamic acid film was self-supporting and was removed from the polyester film. The polyamic acid film was then heated at 200 degrees C. for 30 minutes, at 300 degrees C. for 30 minutes and at 400 degrees C. for 5 minutes to obtain a polyimide film. The polyimide was laminated to copper foil using an adhesive.

### Example 3

4.04 grams of 3,3′-dicarboxy-4,4′-diaminodiphenyl methane diamine (14.1 mmol), 16.02 grams of 4,4′-diaminodiphenyl ether (80 mmol), and 149.7 grams of N,N′-dimethylacetamide were put into 300 ml separable flask equipped with DC stirrer. The mixture was agitated at room temperature under a nitrogen atmosphere for one hour. Next, 19.91 grams (91.3 mmol) of pyromellitic dianhydride was added to the mixture. After one hour of agitation, 9.65 grams of 6.0 wt % pyromellitic dianhydride solution was added over 30 minutes. Agitation was continued for an additional 1 hour to obtain a polyamic acid solution.

Next, 100 grams of the polyamic acid solution was placed into a 200 ml flask and cooled to −10 degrees C. 12.0 g of β- picoline and 12.5 g of acetic anhydride were added to the flask. The contents were agitated under the vacuum for 30 minutes. Next, a portion of the mixture was cast onto glass and heated to 90 degrees C. for 30 minutes. The polyamic acid film was self-supporting and was removed from the glass. The polyamic acid film was then heated at 200 degrees C. for 30 minutes, at 300 degrees C. for 30 minutes and at 400 degrees C. for 5 minutes to obtain a polyimide film. The polyimide was laminated to copper foil using an adhesive.

### Comparative Example 1

38.48 grams of 4,4′-diaminodiphenyl ether (190 mmol) and 320 grams of N,N′-dimethylacetamide were put into 500 ml separable flask equipped with a stirrer. The mixture was agitated at room temperature under nitrogen atmosphere for one hour. Next, 40.27 grams (185 mmol) of pyromellitic dianhydride was added and then agitated for 1 hour. Then 22.01 grams of 6 weight percent pyromellitic dianhydride solution (in DMAc) was added dropwise over 30 minutes. The final mixture was agitated for another hour. A polyimide film was obtained using the same method as Example 1 and was laminated to metal using an adhesive.

The preceding discussion is directed to the preferred embodiments of the present invention only, and nothing within the preceding disclosure is intended to limit the overall scope of this invention. The scope of the present invention is intended to be defined solely by the following claims.

1. A polyamic acid comprising:
i. A first diamine component, wherein the diamine component comprises from 0.1 to 70, mole percent of a diamine represented by 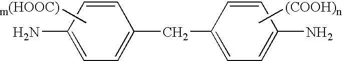
wherein m is 0, 1, 2, 3 or 4, wherein n is 0, 1, 2, 3 or 4, wherein sum of m+n is equal to 1, 3, 4, 5, 6, 7, or 8;
ii. a second diamine component, the second diamine component comprising one or more of the following moities, 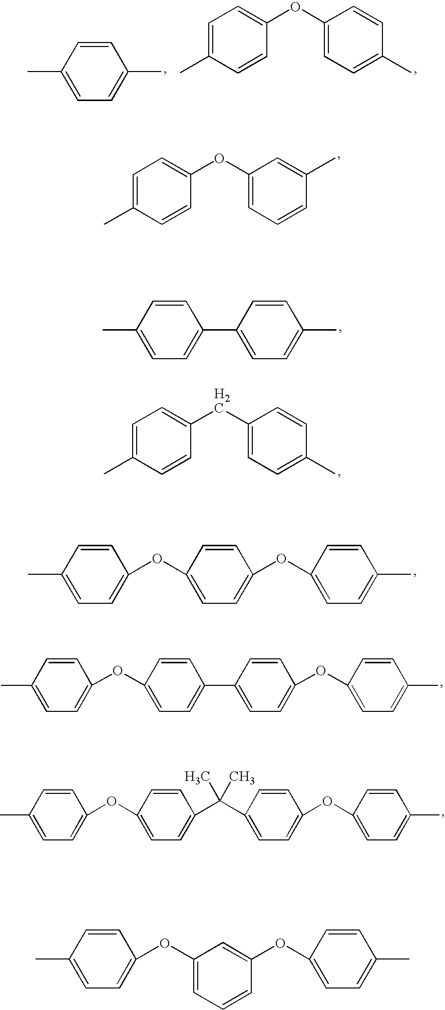
iii. a dianhydride component, wherein the dianhydride component is an aromatic tetracarboxylic dianhydride or chemical derivative thereof, and
iv. a solvent component,
wherein the dianhydride and diamine components are in a molar ratio of aromatic dianhydride component to aromatic diamine component within a range between and including 0.90and 1.10.

2. (canceled)

3. A polyamic acid in accordance with claim 1, wherein the diamine and dianhydride components are dissolved in an organic solvent at a concentration in a range between and including and 90 percent by weight.

4. A polyamic acid in accordance with claim 2, wherein the dianhydride component comprises one or more of the following moieties:

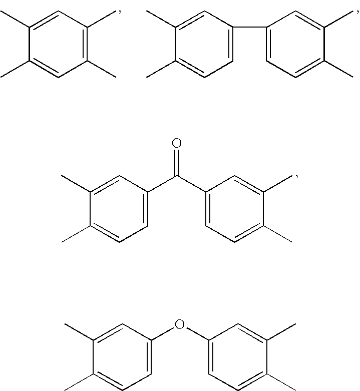

5. A polyamic acid in accordance with claim 3, wherein the solvent comprises a first solvent comprising one or more members of a group consisting of: a sulfoxide solvent, a formamide solvent, an acetamide solvent, a pyrrolidone solvent, a phenol solvent, a hexamethylphosphoramide and a gamma-butyrolactone.

6. A polyamic acid in accordance with claim 5, wherein the solvent also comprises a second solvent comprising one or more members of a group consisting of xylene, toluene, diglyme, propylene glycol methyl ether, propylene glycol, methyl ether acetate, and tetrahydrofuran.
